(19) United States
(12) Patent Application Publication
(10) Pub. No.: US 2015/0366742 A1
(43) Pub. Date: Dec. 24, 2015

(54) AMBULATION SHORTS

(71) Applicant: Medco Technology, LLC, Columbia, SC (US)

(72) Inventors: Sam Chesnutt, Columbia, SC (US); Lucas G. Waldon, New Orleans, LA (US)

(21) Appl. No.: 14/829,332

(22) Filed: Aug. 18, 2015

Related U.S. Application Data
(60) Provisional application No. 62/014,521, filed on Jun. 19, 2014.

(51) Int. Cl. A61H 3/00; A41D 27/00

(52) U.S. Cl. CPC A61H 3/008; A41D 27/00; A61H 2003/007

(57) ABSTRACT

Ambulation shorts configured to fit around upper legs and waist of a patient. The ambulation shorts comprise a garment configured to accommodate the upper legs and the waist of the patient, the garment including a gusset panel secured into the groin area thereof. At least one adjustment mechanism is attached to the garment, the adjustment mechanism adapted to allow the garment to be secure with respect to the patient. At least one lifting strap is attached to an upper portion of the garment and configured to be connected to a patient lift.

### PRIORITY CLAIM

This application is based upon and claims the priority to U.S. provisional application Ser. No. 62/014,521, filed Jun. 19, 2014, which is incorporated fully herein by reference for all purposes.

### FIELD OF THE INVENTION

The present invention relates to devices for increasing ambulation in patients.

### BACKGROUND OF THE INVENTION

Prior to embodiments of the disclosed invention, ambulation slings were cumbersome, uncomfortable, and difficult to apply to and remove from a patient. They resembled a climbing harness and did not take into account the comfort of the patient.

### SUMMARY OF THE INVENTION

The present invention recognizes and addresses the foregoing considerations, and others, of prior art construction and methods.

In this regard, one aspect of the present invention provides ambulation shorts configured to fit around upper legs and waist of a patient. The ambulation shorts comprise a garment configured to accommodate the upper legs and the waist of the patient, the garment including a gusset panel secured into the groin area thereof. At least one adjustment mechanism is attached to the garment, the adjustment mechanism adapted to allow the garment to be secure with respect to the patient. At least one lifting strap is attached to an upper portion of the garment and configured to be connected to a patient lift.

In accordance with some exemplary embodiments, the garment may comprise front and back panels secured together in addition to the gusset panel. For example, the front and back panels may be secured together, such as by stitching, along left and right sides thereof. The at least one lifting strap may comprise at least one front lifting strap attached to the front panel and at least one back lifting strap attached to the back panel. For example, first and second front lifting straps and first and second back lifting straps may be provided.

The ambulation shorts may further comprise a front slidable tensioner extending between the first and second front lifting straps. A back slidable tensioner may also extend between the first and second back lifting straps. Preferably, the slidable tensioners may each be configured as a pocket to store the first and second front lifting straps when not in use.

The lifting straps are preferably configured as a loop with ends attached to the garment. At least one interconnecting webbing may extend across the loop.

In exemplary embodiments, the at least one adjustment mechanism comprises left and right adjustment mechanisms. For example, the adjustment mechanisms are preferably each operative to secure the garment with respect to the patient at a minimum of three locations from the upper leg to the waist of the patient. Each of the adjustment mechanisms may comprise three strap and buckle assemblies. At least one foot pocket may be connected to the garment via a foot pocket strap.

In accordance with another aspect, the present invention provides ambulation shorts configured to fit around upper legs and waist of a patient. The ambulation shorts comprise a garment configured to accommodate the upper legs and the waist of the patient. A set of lifting straps is attached to an upper portion of the garment and configured to be connected to a patient lift. Left and right adjustment mechanisms are attached to the garment, and are adapted to allow the garment to be secure with respect to the patient. In this case, the adjustment mechanisms are each operative to secure the garment with respect to the patient at three or more locations from the upper leg to the waist of the patient. For example, the adjustment mechanisms may comprise three strap and buckle assemblies for adjustment at the upper leg, hip flexor, and the waist of the patient. In exemplary embodiments, the garment may be made from foraminous fabric.

The accompanying drawings, which are incorporated in and constitute a part of this specification, illustrate one or more embodiments of the present invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a front perspective view of ambulation shorts in accordance with an embodiment of the invention in use on a patient;

FIG. 2 is a front perspective view of ambulation shorts in accordance with an embodiment of the invention in use on a patient;

FIG. 3 is a side perspective view of ambulation shorts in accordance with an embodiment of the invention in use on a patient;

FIG. 4 is a back view of ambulation shorts in accordance with an embodiment of the invention in use on a patient;

FIG. 5 is an enlarged front perspective view of ambulation shorts in accordance with an embodiment of the invention in use on a patient;

FIG. 6 is a diagrammatic front elevation of ambulation shorts in accordance with an embodiment of the invention;

FIG. 7 is an enlarged view showing detail of a preferred fabric for use in ambulation shorts in accordance with an embodiment of the invention;

FIGS. 8-9 are back perspective views showing removal of lifting straps from a pocket integrated into a tensioner device;

FIG. 10 is a back perspective view showing slidable adjustment of the tensioner after the lifting straps are attached to a lift device;

FIG. 11 is an enlarged perspective view showing adjustment of the ambulation shorts to be secure on the patient in accordance with an embodiment of the invention; and

FIG. 12 shows ambulation shorts in accordance with an embodiment of the invention removed from a patient and lying flat with optional foot pocket.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

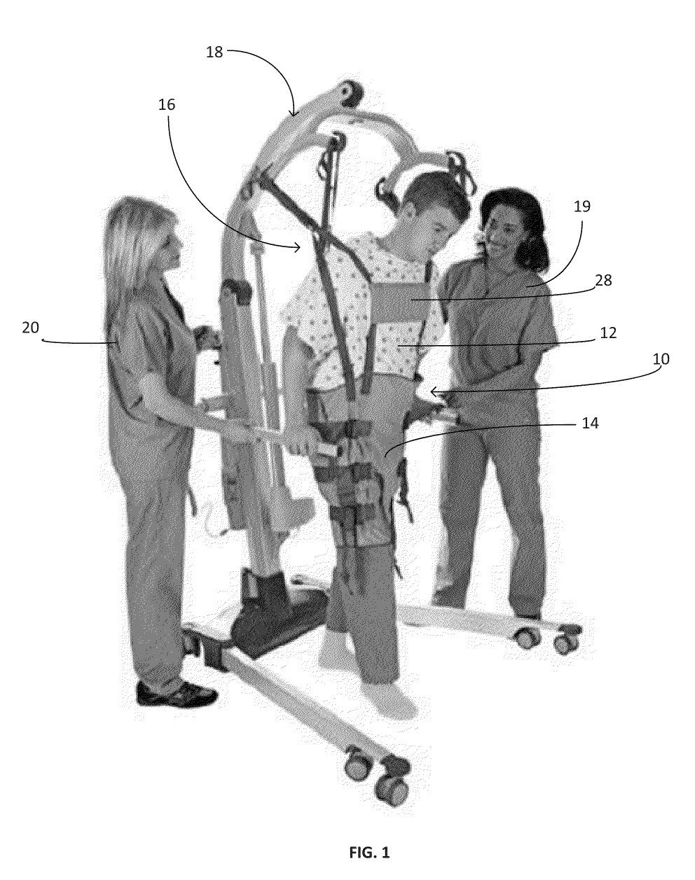

FIG. 1 illustrates ambulation shorts 10 in accordance with an embodiment of the present invention. In this case, ambulation shorts are applied to (i.e., being worn by) a patient 12 to allow patient 12 to ambulate. Generally, ambulation shorts 10 include a garment 14 that accommodates at least the upper legs and waist of patient 12. (One skilled in the art will appreciate that the term “shorts” connotes the area of patient support for ambulation.) As will be explained, one or more adjustment mechanisms are preferably provided to secure the garment snugly against the patient's body. Sets of lifting straps 16 are attached to an upper portion of garment 14. Straps 16 are connected to a lift device 18 (i.e., an overhead support) which supports the patient 12 during ambulation. In this example, patient 12 is being assisted by a pair of caregivers 19 and 20.

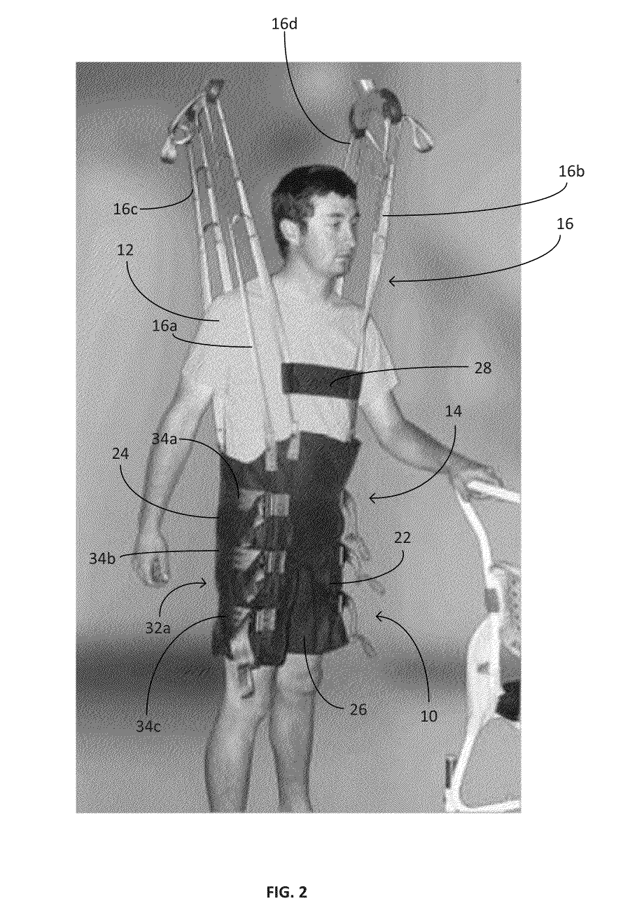

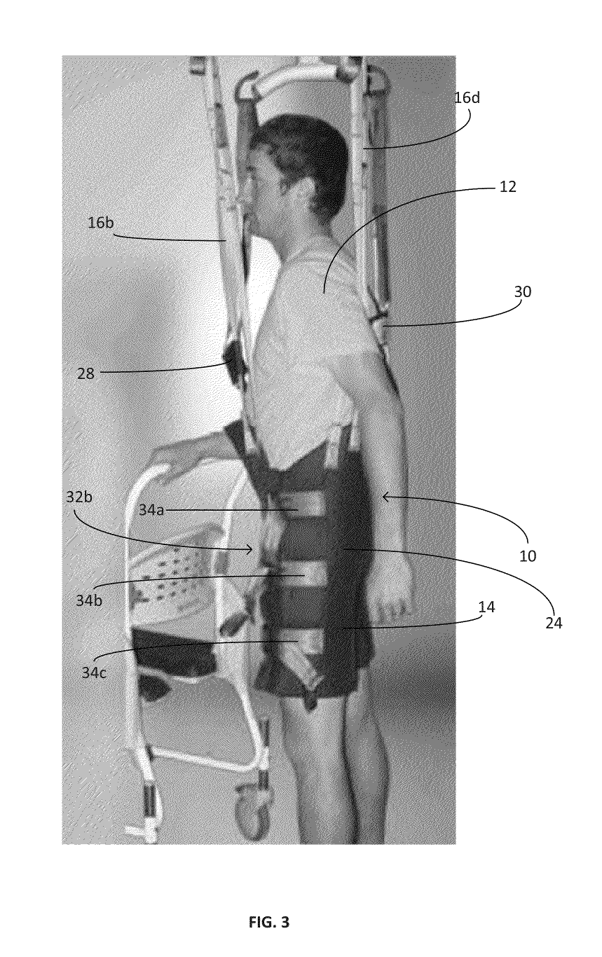

Additional details regarding ambulation shorts 10 can be most easily described with reference to FIGS. 2-5. In this embodiment, garment 14 is constructed having a front panel 22 and a back panel 24 secured together along their respective left and right sides. In addition, garment 14 advantageously has a generally rectangular gusset panel 26 secured to both front panel 22 and back panel 26 in the groin area of garment 14. The use of such a gusset panel is advantageous because it distributes the lifting force on the inside of the patient's legs and lessens discomfort that might otherwise be felt by the patient during use. Preferably, front panel 22, back panel 24, and gusset panel 26 are secured together via appropriate stitching. It may be desirable in some embodiments to provide additional openings in the garment as necessary for passage of various tubes, lines, and the like.

In this embodiment, lifting straps 16 comprise a front pair of lifting straps 16a-b and a back pair of lifting straps 16c-d. In this embodiment, each lifting strap is configured as general flat length of webbing material which is looped and connected at its ends to the upper portion of garment 14. The lifting straps should collectively have sufficient strength to support the weight of the patient in the standing position. One skilled in the art will be able to select an appropriate material for this purpose, although some preferred embodiments may use a nylon webbing of have a width of one inch. Also, it should be understood that, as used herein, the term “strap” refers to any elongated piece of flexible material that is suitable for the intended use.

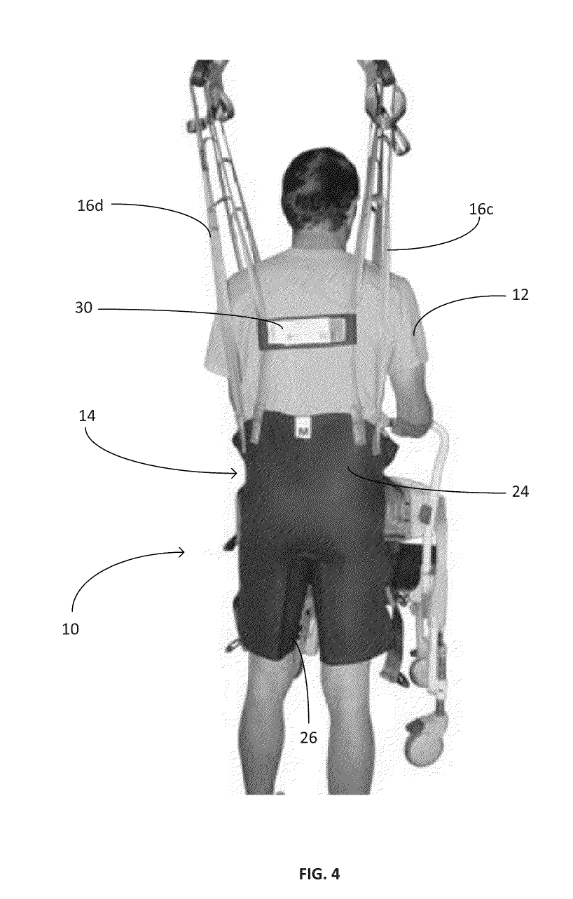

As can be most clearly seen in FIGS. 2 and 4, front and back tensioners 28 and 30 extend between straps 16a-b and 16c-d, respectively. Tensioners 28 and 30 can be slid along the lifting straps once they are connected to the lift device to provide additional support to the patient's chest and back. As will be explained more fully below, tensioners 28 and 30 may be configured as pockets that allow storage of the lifting straps when they are not in use.

As noted above, at least one adjustment mechanism is preferably provided to secure the garment snugly against the patient's body. In this embodiment, for example, right and left adjustment mechanisms 32a-b are provided on right and left sides of garment 12, respectively. In this embodiment, each adjustment mechanism comprises three strap and buckle assemblies 34a-c. Each such strap and buckle assembly comprises a shorter strap carrying a buckle and a longer strap that extends through the buckle for tightening. For example, the shorter strap may be attached to the front panel 22 whereas the longer strap may be attached to the back panel 24. These straps may be formed of 2-inch wide polyester webbing having, for example, respective lengths of six inches and fifteen inches. One skilled in the art will appreciate that the size of garment 12 will depend on the approximate anticipated size of the patient, which may also vary the desired length of these straps. Regardless, the three assemblies 34a-c can be adjusted by simply pulling the longer strap after the garment has been applied to the patient. As a result, the garment will be secured snugly against the patient's waist, hip flexor, and upper leg, respectively.

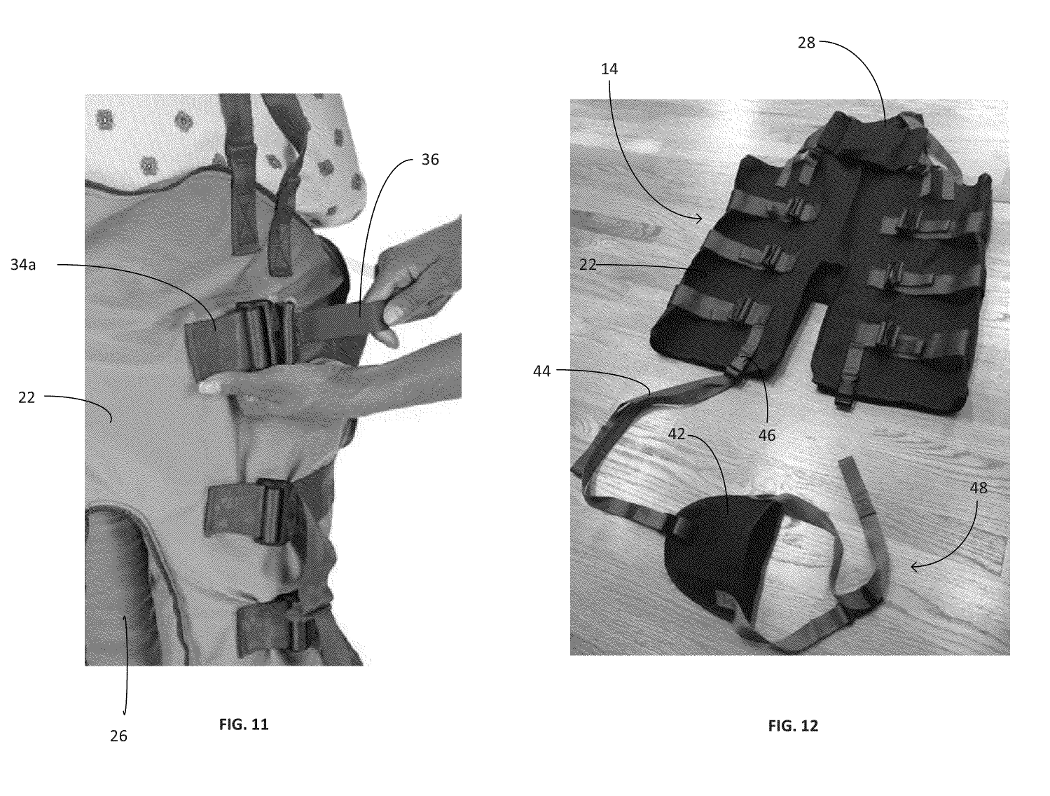

Referring now to FIG. 6, certain additional details can be most easily explained. As can be seen, for example at 36, small pull tabs may be attached to the ends of the longer straps of each strap and buckle assembly 34a-c. These pull tabs may desirably be configured having a high visibility color, such as bright red, to facilitate locating and pulling on them by the caregiver. (FIG. 11 shows a caregiver pulling tab 36 to tighten the left strap and buckle assembly 34a to secure the garment snugly at the patient's waist.) In addition, short lengths of interconnecting webbing, such as the one shown at 38, may be provided across the loop of each lifting strap to assist it in maintaining its shape, and to provide additional structural integrity.

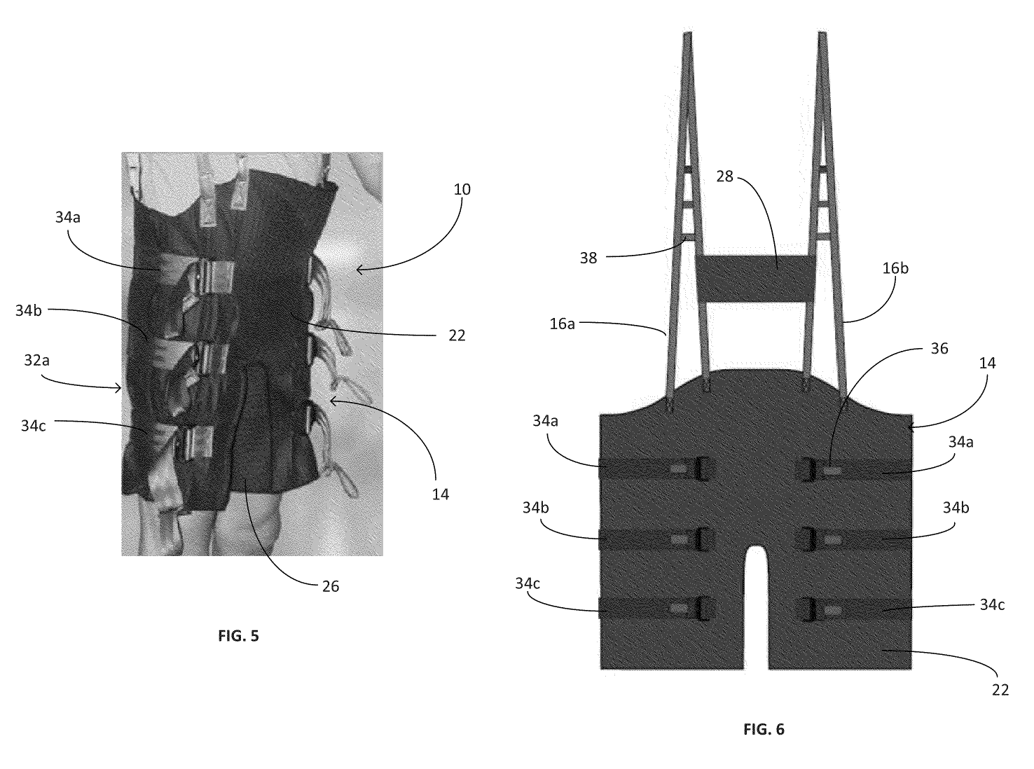

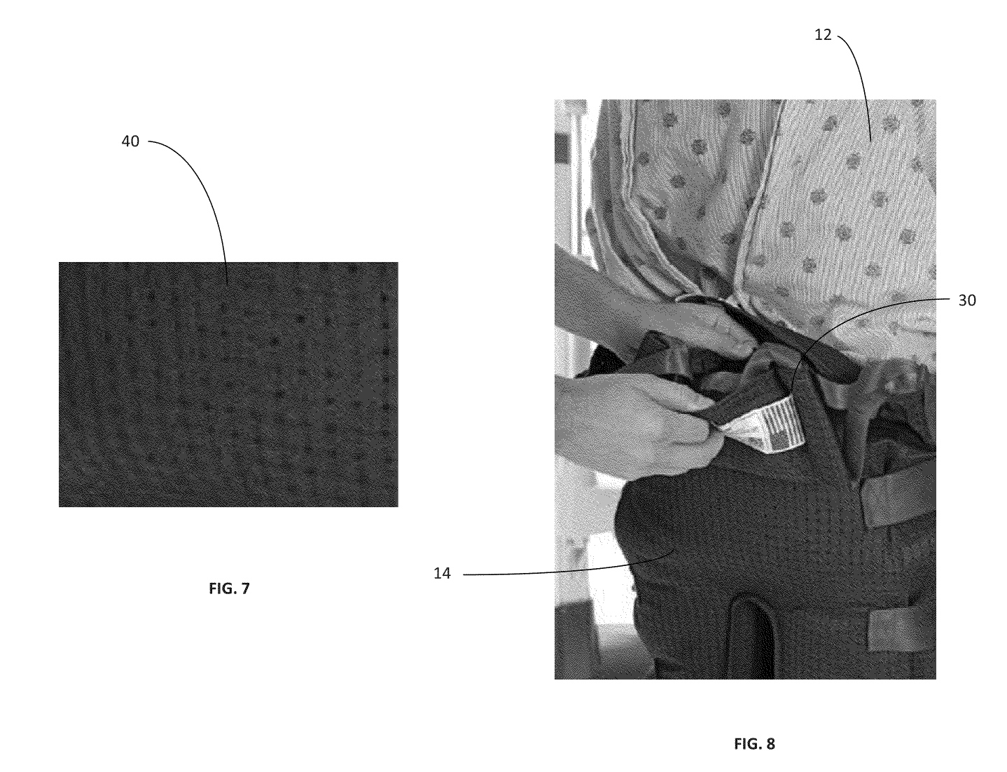

FIG. 7 is an enlarged view of a preferred fabric 40 that may be used to form front panel 22, back panel 24, and gusset panel 26. In this embodiment, fabric 40 comprises a suitable lofted polyester fabric, such as a polyester spacer fabric. As one skilled in the art will recognize, such spacer fabric may be formed of three knitted layers, with the inner layer providing a degree of cushioning. The fabric is preferably foraminous, as shown, to provide ventilation for comfort of the patient.

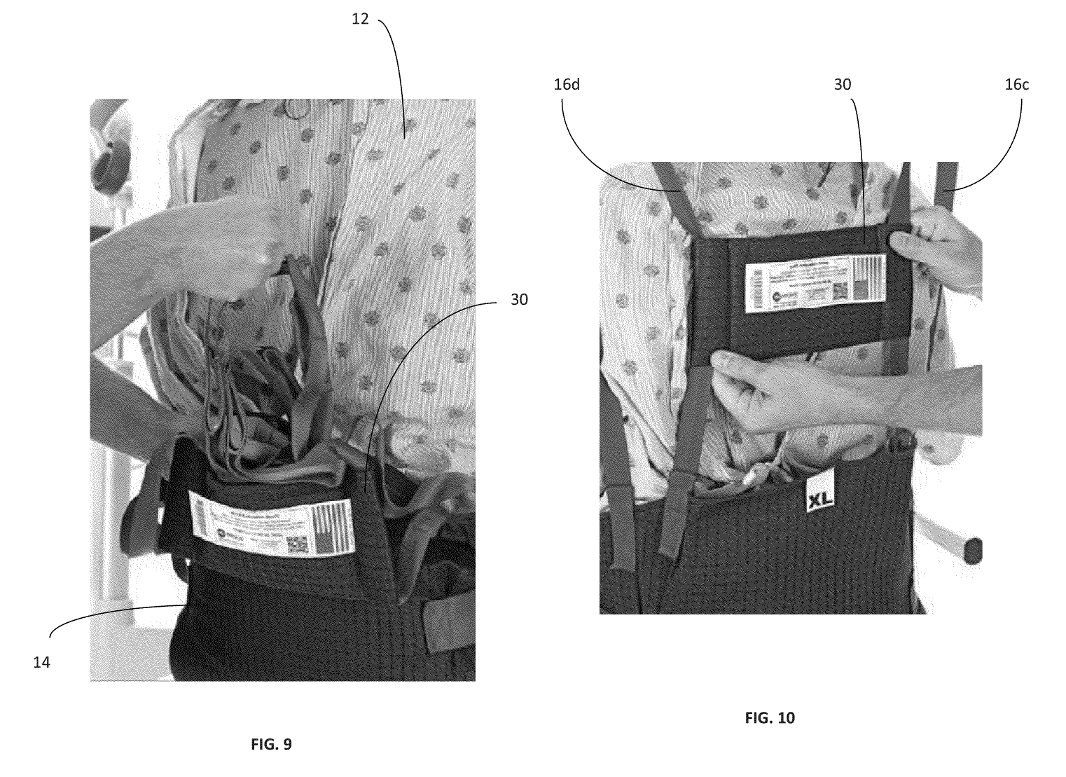

As noted above, tensioners 28 and 30 are preferably formed as pockets in which to store the lifting straps when not in use. This is illustrated in FIGS. 8 and 9, where it can be seen that the lifting straps 16c-d are being removed from tensioner 30 after the garment 14 has been applied to the patient 12. The “mouth” of the pocket formed by the tensioners 28 and 30 may be recloseable, such as using snaps, hook and pile, or other suitable fasteners. As shown in FIG. 10, the tensioner can then be slidably adjusted after the lifting straps are appropriately connected to the lift device, so as to provide support for the patient's chest or back as the case may be.

Referring now to FIG. 12, it may be desirable in some cases to provide one or two foot pockets, such as foot pocket 42, connected to garment 14. In this case, pocket 42 is connected via an adjustable strap 44 to a detachable buckle 46. An adjustable strap arrangement 48 extends around the patient's heel and secures the foot in the pocket 42. Pocket 42 may desirably be used to support the foot of a patient during the ambulation process, such as when the patient has tendon damage. For example, strap 44 may be adjusted so that the foot rests with the toes in a slightly elevated position.

In some embodiments, if a patient is unable to bridge in the ambulation shorts, a slide sheet may be used to assist in sliding the ambulation shorts on. The adjustment mechanisms are then tightened so that the garment is snug, and the lifting straps are connected to the lift device. The lift is raised to the desired position, providing the patient with a level of support. Should the patient fall or slip, the ambulation shorts will support the patient without the discomfort associated with the harness style of ambulation aid.

Those skilled in the art should appreciate that the above description provides novel ambulation shorts. While one or more preferred embodiments of the invention have been described above, it should be understood that any and all equivalent realizations of the present invention are included within the scope and spirit thereof. The embodiments depicted are presented by way of example only and are not intended as limitations upon the present invention. Moreover, it should be understood by those skilled in the art that the present invention is not limited to these embodiments since modifications can be made. Therefore, it is contemplated that any and all such embodiments are included in the present invention as may fall within the scope and spirit thereof.

What is claimed is:

1. Ambulation shorts configured to fit around upper legs and waist of a patient, said ambulation shorts comprising:
a garment configured to accommodate the upper legs and the waist of the patient;
the garment including a gusset panel secured into the groin area thereof;
at least one adjustment mechanism attached to the garment, said adjustment mechanism adapted to allow the garment to be secure with respect to the patient; and
at least one lifting strap attached to an upper portion of the garment and configured to be connected to a patient lift.

2. Ambulation shorts as set forth in claim 1, wherein the garment comprises front and back panels secured together in addition to the gusset panel.

3. Ambulation shorts as set forth in claim 2, wherein said front and back panels are secured together along left and right sides thereof.

4. Ambulation shorts as set forth in claim 3, wherein said front panel, said back panel, and said gusset panel are secured together by stitching.

5. Ambulation shorts as set forth in claim 2, wherein said at least one lifting strap comprises at least one front lifting strap attached to said front panel and at least one back lifting strap attached to said back panel.

6. Ambulation shorts as set forth in claim 5, wherein said at least one front lifting strap comprises first and second front lifting straps and said at least one back lifting strap comprises first and second back lifting straps.

7. Ambulation shorts as set forth in claim 6, further comprising a front slidable tensioner extending between said first and second front lifting straps.

8. Ambulation shorts as set forth in claim 7, further comprising a back slidable tensioner extending between said first and second back lifting straps.

9. Ambulation shorts as set forth in claim 8, wherein said front and back slidable tensioners are each configured as a pocket to store said first and second front lifting straps when not in use.

10. Ambulation shorts as set forth in claim 7, wherein said front slidable tensioner is configured as a pocket to store said first and second front lifting straps when not in use.

11. Ambulation shorts as set forth in claim 5, wherein said at least one front lifting strap and said at least one back lifting strap are each configured as a loop with ends attached to the garment.

12. Ambulation shorts as set forth in claim 11, wherein said at least one front lifting strap and said at least one back lifting strap each comprise at least one interconnecting webbing extending across the loop.

13. Ambulation shorts as set forth in claim 1, wherein said at least one adjustment mechanism comprises left and right adjustment mechanisms.

14. Ambulation shorts as set forth in claim 13, wherein said left and right adjustment mechanisms are each operative to secure the garment with respect to the patient at at least three locations from the upper leg to the waist of the patient.

15. Ambulation shorts as set forth in claim 13, wherein each of said left and right adjustment mechanisms comprises three strap and buckle assemblies.

16. Ambulation shorts as set forth in claim 1, further comprising at least one foot pocket connected to the garment via a foot pocket strap.

17. Ambulation shorts configured to fit around upper legs and waist of a patient, said ambulation shorts comprising:
a garment configured to accommodate the upper legs and the waist of the patient;
a set of lifting straps attached to an upper portion of the garment and configured to be connected to a patient lift;
left and right adjustment mechanisms attached to the garment, said adjustment mechanisms adapted to allow the garment to be secure with respect to the patient; and
wherein said left and right adjustment mechanisms are each operative to secure the garment with respect to the patient at at least three locations from the upper leg to the waist of the patient.

18. Ambulation shorts as set forth in claim 17, wherein each of said left and right adjustment mechanisms comprises three strap and buckle assemblies for adjustment at the upper leg, hip flexor, and the waist of the patient.

19. Ambulation shorts as set forth in claim 17, wherein said garment comprises a front panel, a back panel, and a gusset panel secured together.

20. Ambulation shorts as set forth in claim 17, wherein said set of lifting straps comprises first and second front lifting straps and first and second back lifting straps.

21. Ambulation shorts as set forth in claim 20, further comprising a front slidable tensioner extending between said first and second front lifting straps and a back slidable tensioner extending between said first and second back lifting straps.

22. Ambulation shorts as set forth in claim 21, wherein said front and back slidable tensioners are each configured as a pocket to store said first and second front lifting straps when not in use.

23. Ambulation shorts as set forth in claim 17, wherein lifting straps of said set of lifting straps are each configured as a loop with ends attached to the garment.

24. Ambulation shorts as set forth in claim 17, wherein said garment is made from foraminous fabric.
